(19) United States
(12) Patent Application Publication
(10) Pub. No.: US 2001/0020295 A1
(43) Pub. Date: Sep. 6, 2001

(54) Optical recording medium

(76) Inventor: Hirotsugu Satoh, Kanagawa (JP)

Correspondence Address: Mark J. Thronson, Dickstein Shapiro Morin & Oshinsky LLP, 2101 L Street, N.W., Washington, DC, 20037-1526, US

(21) Appl. No.: 09/783,553

(22) Filed: Feb. 15, 2001

(30) Foreign Application Priority Data
Feb. 28, 2000 (JP) 2000-050972

(51) Int. Cl. G06F 17/00

(52) U.S. Cl. 717/11

(57) ABSTRACT

The present invention relates to an optical recording medium that can prevent illegal use of software, and also can simplify an updating process of the software. This optical recording medium for distributing the software is recordable, and stores a transmission program and a software update program. This optical recording medium is read by a computer so as to start the transmission program and the software update program. By doing so, the inherent ID information allocated only to the optical recording medium can be automatically transmitted to the software distributor. Based on an authentication judgment result of the inherent ID information, the software stored on the optical recording medium itself can be automatically rewritten and updated by update software transmitted from the software distributor. Thus, the software stored on the distributed optical recording medium can be automatically updated to the latest version.

### BACKGROUND OF THE INVENTION

1. Field of the Invention

The present invention relates to an optical recording medium that stores software such as application software, and that is distributed from a software distributor to a software user and used in a computer.

2. Description of the Related Art

Generally, software such as application software used in a computer is acquired by a user who obtains a medium such as a CD-ROM storing the software from a software distributor. The software is normally introduced onto a HDD (Hard Disk Drive) of the computer from the medium. If there are not many changes to be made to the program when the software is updated to the latest version or corrected, the software stored on the HDD can be rewritten and updated by obtaining a difference file distributed by the software producer through a network such as the Internet or obtaining a new medium that stores the difference file.

However, in the conventional software introduction and update method, the distributed medium itself cannot be rewritten to update the contents (i.e., software). If the software is deleted and reintroduced into the computer, or if the software is introduced into another computer, a distributed medium that stores the previous version is temporarily introduced, and an updating program is executed so as to update the software to the latest version. These introduction and update procedures are complicated, which presents a problem in the prior art.

Furthermore, if there are many changes to be made to the software, the user needs to acquire a new medium that stores the software from the software distributor. In such a case, the user takes necessary procedures to acquire the new medium, which might be time consuming.

In a computer into which software is introduced through a medium, the software on the HDD of the computer can be rewritten by connecting the computer to the software distributor via a communication means such as the Internet. In this case, the HDD of a computer into which software illegally copied by a third party has been introduced can be rewritten, and illegal usage of the software cannot be prevented.

If a trouble occurs during the use of software in the computer, the user needs to inform the software producer (or the software distributor),of the trouble and the information concerning the computer currently used. However, it might be difficult for the user or it might take the user a long time to transmit full information concerning the computer, depending on how knowledgeable the user is about the computer.

### SUMMARY OF THE INVENTION

It is a general object of the present invention to provide an optical recording medium that can be protected from illegal usage of software, and can simplify the updating process of the software.

A more specific object of the present invention is to provide an optical recording medium, with which the latest version of software can be introduced in a normal manner without performing complicated procedures when the difference between the latest version and a previous version of software is small and the software only needs to be temporarily deleted and reintroduced or introduced into another computer, and with which a software user can easily and quickly obtain the latest version of software when the difference between the latest version and the previous version of software is large.

Another specific object of the present invention is to provide an optical recording medium, with which the information concerning the computer currently used can be readily and accurately transmitted to the software distributor when a trouble occurs during the use of the software, regardless of how knowledgeable the user is about the computer, so that the trouble can be easily dealt with by both the software user and the software producer.

The above objects of the present invention are achieved by an optical recording medium that is computer-readable and -writable, and stores software to be distributed, non-rewritable inherent ID information, and a transmission program for transmitting the inherent ID information to a software distributor via a communication means.

The optical recording medium is read by a computer to start the transmission program, thereby automatically transmitting the inherent ID information allocated only to the optical recording medium to the software distributor. Based on the inherent ID information, the update software and the like can be received from the software distributor. Here, the software distributor can determine from the non-rewritable inherent ID information whether or not each user is a properly registered user. Thus, the software can be protected from illegal use. Furthermore, since the optical recording medium is writable, received update software can be written on the optical recording medium, thereby updating the software on the distributed optical recording medium to the latest version.

The above objects of the present invention are also achieved by an optical recording medium that is computer-readable and -writable, and stores software to be distributed, non-rewritable inherent ID information, and a software update program for rewriting and updating the software by update software transmitted from the software distributor via a communication means in accordance with an authentication judgment result based on the inherent ID information.

This optical recording medium is read by a computer to start the software update program, thereby automatically rewriting and updating the software on the optical recording medium by the update software received via the communication means such as the Internet. Thus, the software recorded on the distributed optical recording medium can be updated to the latest version. Here, the software distributor can determine from the non-rewritable inherent ID information whether or not the user is a properly registered user. Thus, the software can be protected from illegal use.

The above objects of the present invention are also achieved by an optical recording medium that is computer-readable and -writable, and stores software to be distributed, non-rewritable inherent ID information, a transmission program for transmitting the inherent ID information to a software distributor via a communication means, and a software update program for rewriting and updating the software by update software transmitted from the software distributor in accordance with an authentication judgment result based on the inherent ID information.

This optical recording medium is simply read by a computer so as to start the transmission program and the software update program. By doing so, the inherent ID information allocated only to the optical recording medium is automatically transmitted to the software distributor, and the software stored on the optical recording medium can be automatically rewritten and updated by receiving the update software transmitted from the software distributor in accordance with the authentication judgment result of the inherent ID information. Thus, the software stored on the distributed optical recording medium can be automatically updated to the latest version. For instance, if there are not many changes between the latest version and a previous version of software, the latest version of software can be easily introduced in a conventional manner, without carrying out complicated processes to delete and reintroduce the software or to introduce the software to another computer. Also, even if there are many changes between the latest version and the previous version of the software, the optical recording medium is simply rewritten and updated, thereby promptly obtaining the latest version of the software. During the above processes, the software distributor can determine from the non-rewritable inherent ID information whether or not each user is a properly registered user. Thus, the software can be protected from illegal use.

Other objects and further features of the present invention will become more apparent from the following description taken in conjunction with the accompanying drawings.

### BRIEF DESCRIPTION OF THE DRAWINGS

FIG. 1 shows the structure of a software management system of one embodiment of the present invention;

FIG. 2 is a schematic view of the structure of an optical disk in accordance with the present invention;

FIG. 3 is a flowchart of a first example of an operation using the optical disk of the present invention;

FIG. 4 is a flowchart of a second example of an operation using the optical disk of the present invention;

FIG. 5 is a flowchart of a third example of an operation using the optical disk of the present invention; and

FIG. 6 is a flowchart of a fourth example of an operation using the optical disk of the present invention.

### DESCRIPTION OF THE PREFERRED EMBODIMENTS

The following is a description of embodiments of the present invention, with reference to the accompanying drawings.

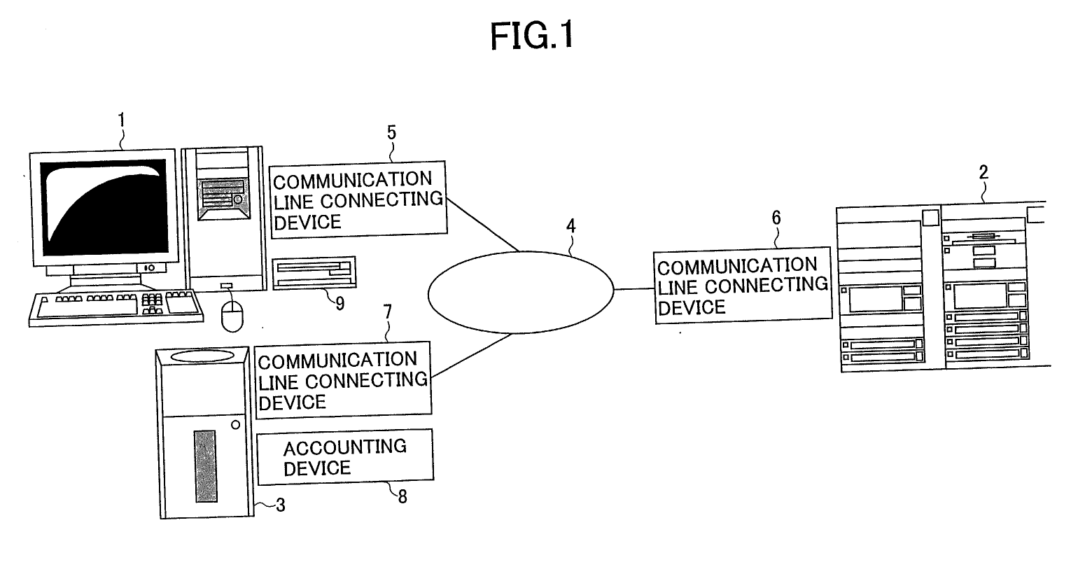

FIG. 1 shows the structure of a software management system in which an optical recording medium of the present invention is used. This system comprises: a general computer 1 that is used by a software user; a software distributor host computer 2 (hereinafter referred to simply as “host computer 2”) owned by a software producer; and a disk rewrite device 3 that is provided by the software producer and situated at a place such as a shop. The general computer 1, the software distributor host computer 2, and the disk rewrite device 3 are communicably connected to each other via a communication network 4 that utilizes a public communication network, privates lines, or the Internet. The general computer 1, the host computer 2, and the disk rewrite device 3 include communication line connecting devices 5, 6, and 7, respectively, such as modems or network cards. The communication line connecting devices 5, 6, and 7 constitute a communication unit with the communication network. The disk rewrite device 3 may have an accounting device 8.

The general computer 1 integrally or separately has an optical disk drive device 9. With the optical disk drive device 9, the general computer 1 can read information recorded on an optical recording medium. The optical disk drive device 9 may be a drive that can record and reproduce, or a read-only drive such as a CD-ROM drive.

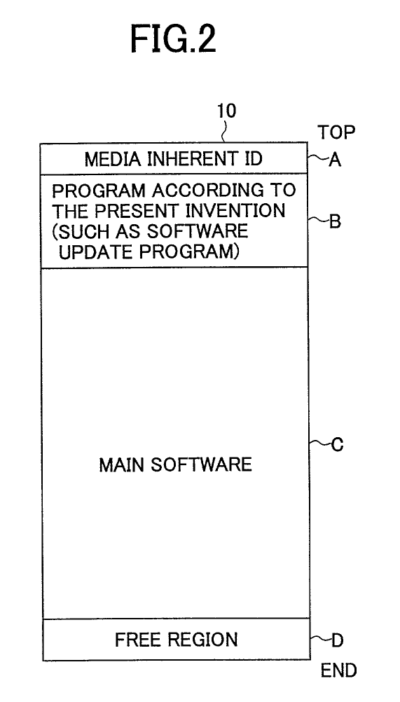

FIG. 2 is a schematic view of the data structure of an optical disk 10 that is an optical recording medium in accordance with the present invention. This optical disk 10 stores application software to be distributed and is distributed to software users for payment or for free. It is notable that a rewritable disk such as a CD-RW or CD-R can be used for the optical disk 10, instead of a conventional read-only disk such as a CD-ROM. It is more preferable to use a rewritable disk such as a CD-RW, but a write-once disk such as a CD-R can be substantially rewritten. Accordingly, no distinction will be made between a CD-RW and a CD-R in the following description of the present invention.

In the writable optical disk 10, a region A in the vicinity of the top stores inherent ID information allocated intrinsically to the optical disk 10. The inherent ID information is recorded in a ROM state in which no rewriting operation can be performed once the data is recorded by the software distributor. A region B that follows the region A stores programs such as a transmission program, a software update program, and a computer information acquiring program. These programs in the region B are also recorded in the ROM state in which no rewriting operation can be performed once the data is recorded by the software distributor. A region C that follows the region B stores main software, such as application software to be distributed, in a rewritable state. A region D that follows the region C is used as a free region. In other words, the regions A and B are ROM regions, and the regions C and D are RAM regions.

Here, the program stored in the region B will be described below. The “transmission program” is prepared as a part of a “software update program” or a “trouble information transmission program”. By starting the transmission program, the inherent ID information stored on the optical disk 10 is automatically transmitted to the host computer 2 via the communication line connecting device 5, the communication network 4, and the communication line connecting device 6. As the “software update program” is started, the optical disk drive device 9 (if it has a recording function) is actuated, and the software in the region C on the optical disk 10 is automatically rewritten and updated with the update software transmitted from the host computer 2 to the general computer 1 via the communication line connecting device 6, the communication network 4, and the communication line connecting device 5. The “computer information acquiring program” is a part of the “trouble information transmission program”. As the computer information acquiring program is started, the information of the general computer 1 that is currently using the optical disk 10 is automatically acquired. This program itself is known and commercially available. The information to be acquired by the general computer 1 is used when a trouble occurs, and includes the version information of the hardware connected to the general computer 1, the OS software, and the files, for instance. If the “computer information acquiring program” is started by the “trouble information transmission program”, the “transmission program” has a function to transmit the acquired information of the general computer 1, as well as the inherent ID information, to the host computer 2.

As will be described later, the host computer 2 has functions to determine whether or not the transmitted inherent ID information can be authenticated based on the user registration in the user information database, and to distribute automatically the update software if the inherent ID information is authenticated.

In the above structure, if the optical disk 10 for distributing software is used, there should be several example operations performed by the CPUs of the general computer 1, the host computer 2, and the disk rewrite device 3. In the following, each example operation will be described.

[First Example]

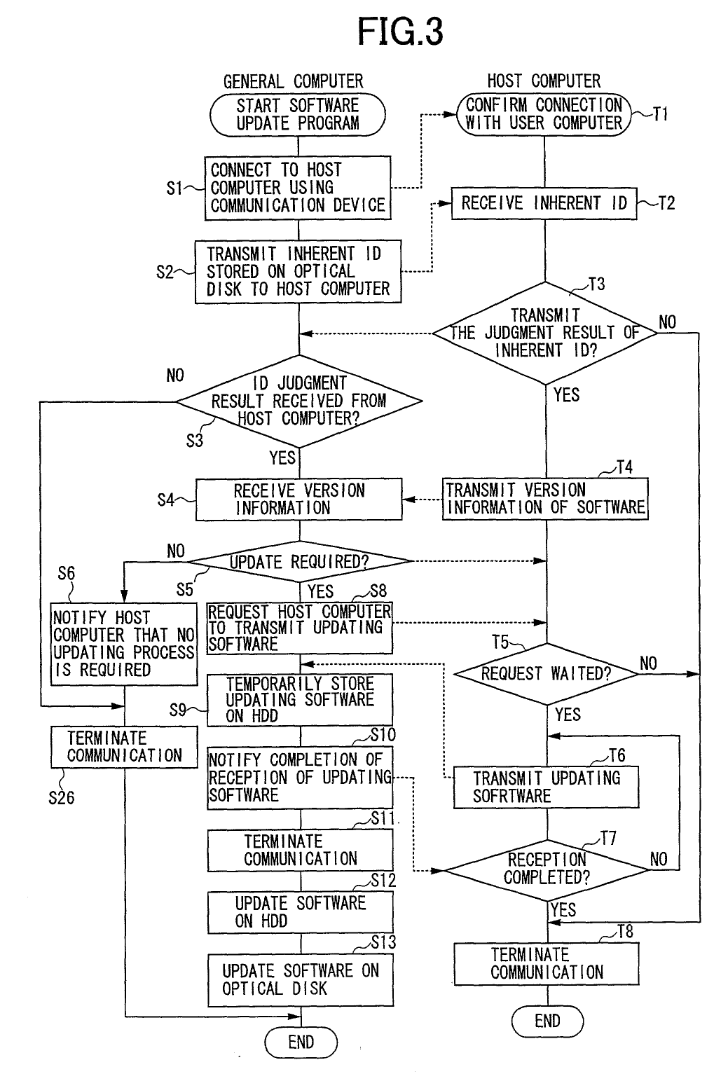

FIG. 3 is a flowchart of a case where a software producer (or a software distributor) distributes the optical disk 10 without distinguishing a software user with the inherent ID information, and the optical disk drive device 9 used by the software user can record and reproduce data.

The software user first inserts the optical disk 10 into the optical disk drive device 9, and starts the “software update program” automatically or through a predetermined operation on the general computer 1. The communication unit, which is constituted by the communication line connecting device 5, the communication network 4, and the communication line connecting device 6), is controlled so that the general computer 1 is connected to the host computer 2 corresponding to the software distributor of the optical disk 10 in step S1. The host computer 2 then confirms the connection with the general computer 1 of the software user in step T1.

In the connected state, the “transmission program” stored on the optical disk 10 is started so that the inherent ID information allocated to the optical disk 10 is automatically transmitted to the host computer 2 via the communication unit (i.e., the communication line connecting device 5, the communication network 4, and the communication line connecting device 6) in step S2. In response to the transmission step, the host computer 2 performs a receiving process of the inherent ID information in step T2. The host computer 2 then determines whether or not the received inherent ID information has been set by the software distributor in step T3. If the received inherent ID information has not been set by the software distributor, the communication is terminated in step T8, and the operation is ended. If the received inherent ID information has been set by the software distributor, the host computer 2 transmits the result to the general computer 1, and requests the general computer 1 to transmit the version information of each of the files that constitute the software corresponding to the inherent ID information in step T4. After the general computer 1 is notified by the host computer 2 that the received inherent ID information has been set by the software distributor in step S3, the general computer 1 performs a receiving process of the version information of each file in step S4. After receiving the version information, the general computer 1 compares the received version information with the version information of the corresponding file of the software introduced in the HDD of the general computer 1, thereby determining whether or not a software updating process needs to be performed in step S5. If it is determined in step S5 that no software updating process is required, the general computer 1 notifies the host computer 2 that no software updating process is required in step S6. The communication is then terminated in step S7, and the operation comes to an end.

Meanwhile, if it is determined in step S5 that a software updating process is required, the general computer 1 requests the host computer 2 to transmit update software in step S8. After the transmission of the version information, the host computer 2 is in a request waiting state in step T5. When receiving a response notifying that no software updating process is required, the host computer 2 terminates the communication in step T8, and ends the operation. On the other hand, when receiving a request for transmission of the update software, update software held by the host computer 2 is transmitted to the general computer 1 in step T6.

After receiving the update software, the general computer 1 temporarily stores the update software on the HDD in step S9. When the reception of all the update software is completed, the general computer 1 notifies the host computer 2 that all the update software has been received in step S10. Until receiving this notification, the host computer 2 is in a reception waiting state in step T7, and repeats the transmission of update software, if necessary.

After the general computer 1 finishes notifying the host computer 2 that the reception of all the update software is completed in step S11, the general computer 1 terminates the communication with the host computer 2 in step S11. Also, the general computer 1 rewrites and updates the software on the HDD with the update software in step S12. Further, the general computer 1 starts the “software update program” stored on the optical disk 10, thereby driving the optical disk drive device 9. Thus, the software in the region C of the optical disk 10 is automatically rewritten and updated with the update software stored on the HDD in step S13. In other words, the software of the optical disk 10, which was distributed from the software distributor, is rewritten and updated to the latest version. In the prior art, the recording operation on an optical disk was time consuming, but a high-speed recording operation can be performed on the optical 10 by the optical disk drive device 9. As the data rewrite time required for the optical disk 10 is shorter, it is considerably advantageous that the software of the optical disk 10, which was originally distributed by the software distributor, can be rewritten and updated to the latest version.

[Second Example]

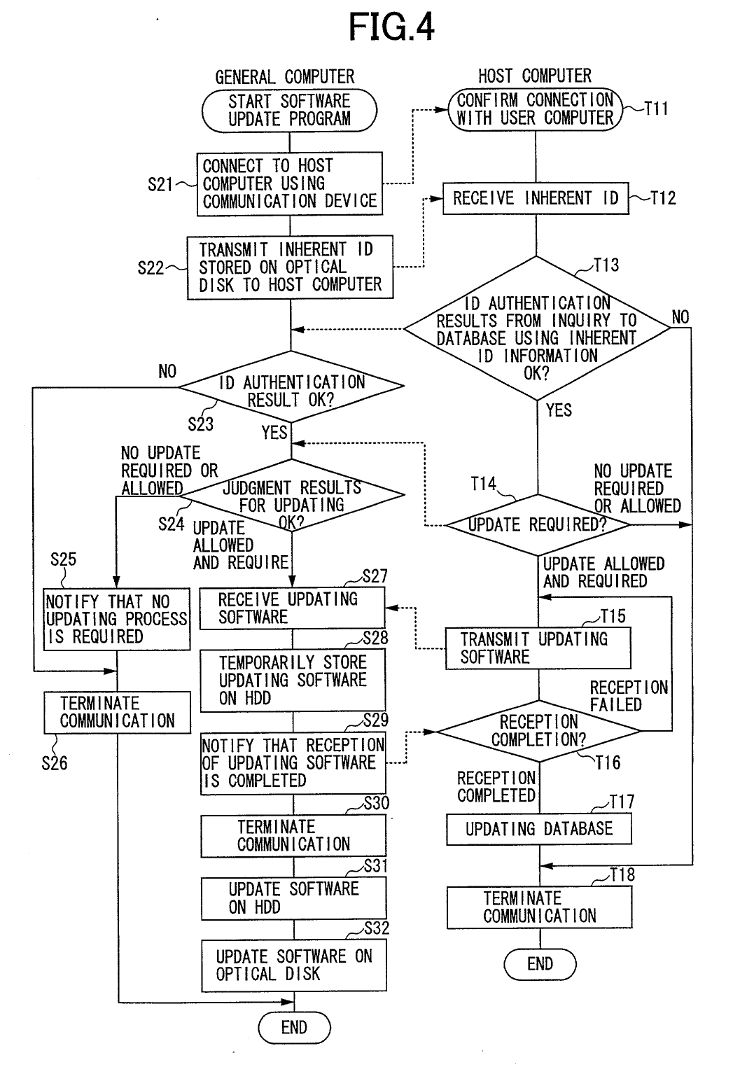

FIG. 4 is a flowchart of a case where a software producer (or a software distributor) distinguishes a software user with the inherent ID information and distributes the optical disk 10 that stores the predetermined inherent ID information and that is accompanied by a user registration operation (the host computer 2 is provided with a user information database as to each user using the inherent ID information), and where the optical disk drive device 9 used by the software user can be recorded and reproduced.

First, with the optical disk 10 being mounted on the optical disk drive device 9, the software user starts the software update program automatically or through a predetermined operation on the general computer. The communication device, which is constituted by the communication line connecting device 5, the communication network 4, and the communication line connecting device 6, is then controlled to connect the general computer 1 to the host computer 2 corresponding to the software distributor of the optical disk 10 in step S21. In response to this, the host computer 2 confirms the connection with the general computer 1 of the user in step T11.

Once in a connected state, the “transmission program” stored on the optical disk 10 is started so as to automatically transmit the inherent ID information allocated to the optical disk 10 to the host computer 2 via the communication device, which is constituted by the communication line connecting device 5, the communication network 4, and the communication line connecting device 6, in step S22. Upon receipt of the inherent ID information, the host computer 2 performs a receiving operation of the inherent ID information in step T12. The host computer 2 then inquires about the received inherent ID information from the user information database, and performs an ID authentication process to determined whether or not the received inherent ID information has been properly set by the software distributor in step T13. If the authentication judgment result does not indicate that the received inherent ID information is proper information, the communication is terminated in step T18, and the operation comes to an end. On the contrary, if the authentication judgment result indicates that the received inherent ID information is proper information, the host computer 2 transmits the result to the general computer 1, and determines whether or not a software updating process is required and can be permitted by comparing the software version information already distributed to the software user having the inherent ID information with the latest version information of the corresponding software in step T14. If it is determined that no software updating process is required as a result of the comparison, the communication is terminated in step T18, and the operation comes to an end. On the contrary, if the software already distributed to the software user is older, and a software updating process is allowed by the software producer (the host computer 2), a software updating process is required, and the update software is transmitted to the general computer 1 in step T15.

Meanwhile, if the general computer 1 receives an authentication judgment result indicating that the received inherent ID information is not proper information, the communication is terminated in step S26, and the operation comes to an end. On the contrary, if the authentication judgment result indicates that the received inherent ID information is proper information, the general computer 1 waits for a judgment result as to necessity and allowability of a software updating process in step S24. If no software updating process is necessary or allowed (for instance, in a case where a bill has not been settled), the general computer 1 notifies the host computer that no software updating process is necessary in step S25. The communication is then terminated in step S26, and the operation comes to an end. If a software updating process is required and allowed, the general computer 1 performs a receiving operation of the update software transmitted from the host computer 2 in step S27. The update software is temporarily stored on the HDD in step S298. When the reception of the whole update software is completed, the general computer 1 notifies the host computer 2 that the reception of the update software has been finished in step S29. Until the notification of the reception completion, the host computer 2 is in a waiting state for the notification in step T16, and repeats the transmission of the update software as long as it is necessary.

After the notification of the reception completion of the update software in step S29, the general computer 1 terminates the communication with the host computer 2 in step S30, and rewrites and updates the software on the HDD in accordance with the update software in step S31. Further, the general computer 1 starts the “software update program” stored on the optical disk 10, thereby actuating the optical disk drive device 9. Thus, the software in the region C stored on the optical disk 10 is automatically rewritten and updated in accordance with the update software stored on the HDD in step S32. In this manner, the software of the optical disk 10 distributed by the software distributor is rewritten and updated to the latest version.

If accounting procedures are necessary for rewriting or update software, a software user makes the payment in advance, and the host computer 2 records information that indicates the settlement of the account and the allowance of the updating of the software on the user information database. If no payment has been made, the updating of the software of the software user is recorded as “unallowable” on the user information database. Accordingly, no software updating process cannot be performed.

[Third Example]

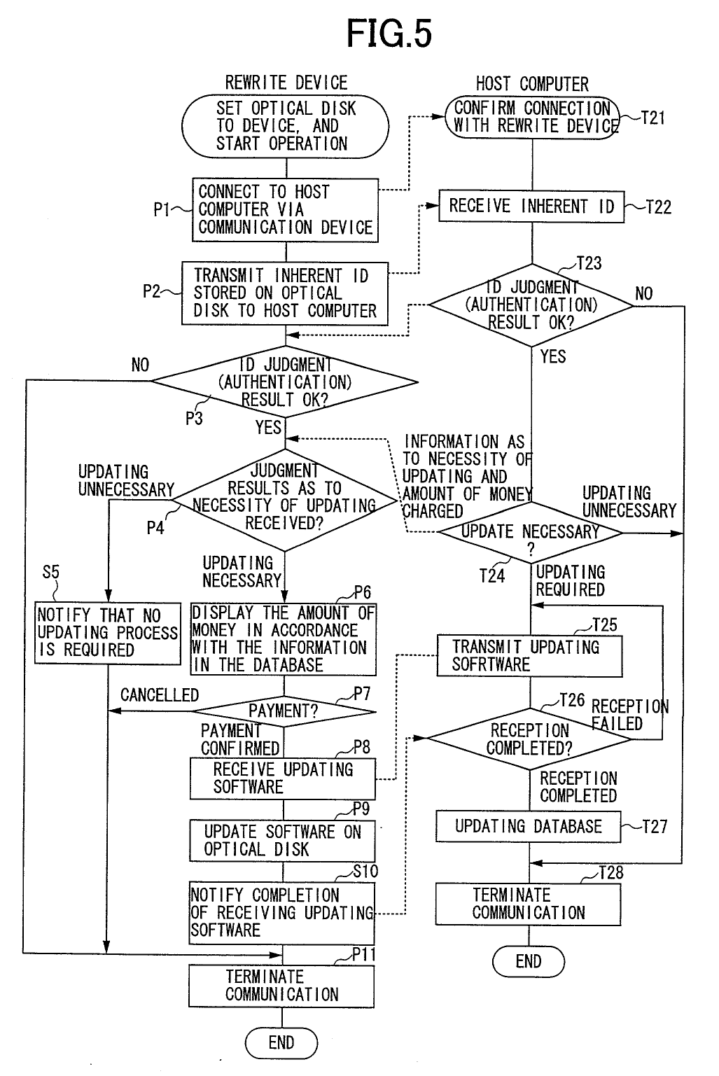

FIG. 5 is a flowchart of a case where the optical disk drive device 9 used by the software user is a read-only drive regardless of whether or not the software producer (the software distributor) distinguishes each software user. However, the host computer 2 is provided with a user information database as to each user using inherent ID information.

In this case, each software user takes the optical disk 10 to a location at which the disk rewrite device 3 is located, and rewrites and updates the software with the disk rewrite device 3.

The optical disk 10 is inserted into the disk rewrite device 3 to start the operation. The communication device (constituted by the communication line connecting device 7, the communication network 4, and the communication line connecting device 6) is then controlled so as to connect the disk rewrite device 3 to the host computer 2, which is the distributor of the optical disk 10 in step P1. The host computer 2 in turn confirms the connection with the disk rewrite device 3 in step T21.

Once in a connected state, the disk rewrite device 3 starts the “transmission program” stored on the optical disk 10, so that the inherent ID information allocated to the optical disk 10 is automatically transmitted to the host computer 2 via the communication device (constituted by the communication line connecting device 7, the communication network 4, and the communication line connecting device 6) in step P2.

In response to the transmission process, the host computer 2 performs a receiving process of the inherent ID information in step T22. The host computer 2 then makes an inquiry about the received inherent ID information, and performs an ID authentication process to determine whether or not the received inherent ID information is information properly set by the software distributor in step T23. If it is determined that the received inherent ID information is not proper information, the communication is terminated in step T28, and the operation comes to an end. If the received inherent ID information is proper information, the authentication judgment result is transmitted to the disk rewrite device 3, and determines whether or not a software updating process is necessary by comparing the version information of software already distributed to the software user having the inherent ID information with the latest version information of the corresponding software in step T24. If it is determined that a software updating process is unnecessary as a result of the comparison, the communication is terminated in step T28, and the operation comes to an end. On the contrary, if it is determined that the software already distributed to the software user is older, the host computer 3 transmits information of a necessary amount of charge to the software user, and sends the update software to the disk rewrite device 3 in step T25.

Meanwhile, the disk rewrite device 3 receives the authentication judgment result in step P3. If the authentication judgment result indicates that the inherent ID information is not proper information, the communication is terminated in step P11, and the operation comes to an end. If the authentication judgment result indicates that the inherent ID information is proper information, the disk rewrite device 3 waits for information of the necessity of a software updating process and the amount of money required in step P4. If no updating process is necessary, the disk rewrite device 3 notifies the host computer 2 that no updating process is required in step P5, and terminates the communication in step P11. The operation then comes to an end. On the contrary, if an updating process is required, the disk rewrite device 3 displays the information of the amount of required money transmitted in accordance with the database in the host computer 2 in step P6, and then waits for a payment made through the accounting device 8 in step P7. If the payment is cancelled, the communication is terminated in step P11, and the operation comes to an end. If a payment is confirmed, the disk rewrite device 3 performs a receiving process of the update software transmitted from the host computer 2 in step P8, and automatically rewrites and updates the software in the region C on the optical disk 10 with the update software in step P9. Thus, the software of the optical disk 10 distributed by the software distributor is rewritten and updated to the latest version. When the reception of the update software is completed, the disk rewrite device 3 notifies the host computer 2 that the reception of the update software is completed in step P10. The disk rewrite device 3 then terminates the communication with the host computer 2 in step P11, and the operation comes to an end.

After the rewrite and update process by the disk rewrite device 3 is completed, the software user takes the optical disk 10 back, and deletes the former version of the software in the general computer 1, if necessary. The software user then uses the rewritten and updated optical disk 10, and introduces the software of the latest version in the normal procedures.

[Fourth Example]

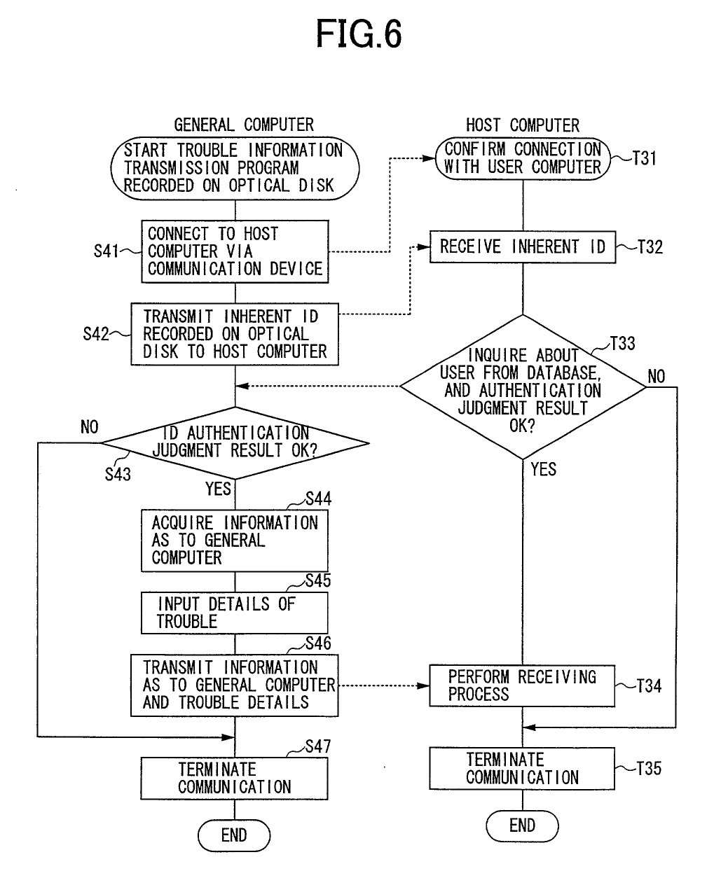

FIG. 6 is a flowchart of a case where the software producer (the software distributor) distinguishes each software user with inherent ID information, and distributes the optical disk 10, on which the predetermined inherent ID information is recorded. When distributing the optical disk 10, the software distributor also carries out a user registration operation. Therefore, the host computer 2 is provided in advance with a user information database that utilizes the inherent ID information.

If a trouble is caused while the software on the HDD corresponding to the software stored on the optical disk 10 is used in the general computer 1, the software user tries to inquire for a solution from the software producer, and starts the “trouble information program” stored on the optical disk 10.

Once this program is started, the communication device, which is constituted by the communication line connecting device 5, the communication network 4, and the communication line connecting device 6, is controlled so as to connect the general computer 1 to the host computer 2, which is the software distributor of the optical disk 10 in step S41. In response to this, the host computer 2 confirms the connection with the user computer in step T31.

Once in a connected state, the general computer 1 starts the “transmission program” stored on the optical disk 10, thereby automatically transmitting the inherent ID information allocated to the optical disk 10 to the host computer 2 via the communication device constituted by the communication line connecting device 5, the communication network 4, and the communication line connecting device 6 in step S42. In response to the transmission process, the host computer 2 performs a receiving process of the inherent ID information in step T32. The host computer then makes a request for the received inherent ID information from the user information database, and performs an ID authentication process to determine whether or not the received inherent ID information is information properly set by the software distributor in step T33. If the received inherent ID information is not proper information set by the software distributor, the communication is terminated in step T35, and the operation comes to an end. If the received inherent ID information is proper information, the host computer 2 transmits the authentication judgment result to the general computer 1.

Meanwhile, the general computer 1 receives the authentication judgment result in step S43. If the authentication judgment result indicates that the received inherent ID information is not proper information, the general computer 1 terminates the communication in step S47, and the operation comes to an end. If the authentication judgment result indicates that the received inherent ID information is proper information, the “computer information acquiring program” stored on the optical disk 10 is started so as to automatically acquire information of the general computer 1 in step S44. For instance, the version information concerning the hardware actually connected to the general computer 1, the OS software, and files, is obtained. The general computer 1 then displays a message to prompt the user to input the details of the trouble, and waits for the user to input them in step S45. After a notification of completion of the input, the “transmission program” stored on the optical disk 10 is started so as to automatically transmit the details of the trouble inputted by the user, as well as the information concerning the general computer 1 automatically obtained, to the host computer 2 in step S46. The communication with the host computer 2 is then terminated in step S47, and the operation comes to an end. In this manner, the information of the general computer 1 and the details of the trouble can be easily and accurately obtained, regardless of the user's knowledge of the software. Accordingly, troubles can be easily dealt with by both the software user and the software producer, and swift and appropriate solutions can be attained.

As described so far, the optical disk 10, on which data can be recorded, is used as an optical disk for distributing software, and the general computer 1 reads the optical disk 10. The transmission program and the software update program on the optical disk 10 are then started so as to automatically transmit the inherent ID information allocated only to the optical disk 10. Based on the ID authentication judgment result, the update software is received from the host computer 2, so that the software on the optical disk 10 can be automatically rewritten and updated. Thus, the software on the distributed optical disk 10 can be automatically updated to the latest version, thereby making the optical disk 10 more user-friendly. For instance, even if there is no major changes in software between a previous version and the latest version, it is unnecessary to perform a complicated operation to delete the previous version and introduce the latest version, or to introduce the latest version to another computer. The latest version can be introduced in the conventional manner by simply using the updated optical disk 10. Also, in a case where major changes are made to the previous version, the software on the optical disk 10 should be simply rewritten and updated. Thus, the latest version can be promptly obtained. In those processes, the host computer 2 can determine from the non-rewritable inherent ID information whether or not each user is a proper user, and provide the update software only to proper users. Thus, improper or illegal usage of software can be prevented.

The present invention is not limited to the specifically disclosed embodiments, but variations and modifications may be made without departing from the scope of the present invention.

The present invention is based on Japanese patent application No. 2000-050972 filed on Feb. 28, 2000, the entire contents of which are hereby incorporated by reference.

What is claimed is:

1. An optical recording medium that is computer-readable and -writable, which medium stores software to be distributed, non-rewritable inherent ID information, and a transmission program for transmitting the inherent ID information to a software distributor via a communication device.

2. An optical recording medium that is computer-readable and -writable, which medium stores software to be distributed, non-rewritable inherent ID information, and a software updating program for rewriting and updating the software in accordance with update software transmitted from a software distributor via a communication device based on an authentication judgment result of the inherent ID information.

3. An optical recording medium that is computer-readable and -writable, which medium stores software to be distributed, non-rewritable inherent ID information, a transmission program for transmitting the inherent ID information to a software distributor via a communication device, and a software updating program of rewriting and updating the software in accordance with update software transmitted from the software distributor via the communication device based on an authentication judgment result of the inherent ID information.

4. The optical recording medium as claimed in claim 1, further storing a computer information acquiring program for acquiring information of a computer that is currently using the optical recording medium,
wherein the transmission program transmits the information of the computer, as well as the inherent ID information, to the software distributor.

5. A method of updating software distributed and stored in a computer-readable and -writable optical recording medium, said method comprising the steps of:
transmitting non-rewritable inherent ID information to a software distributor via a communication device;
rewriting and updating the software in accordance with update software transmitted from the software distributor via the communication device based on an authentication judgment result of the inherent ID information.
